(19) United States
(12) Patent Application Publication
(10) Pub. No.: US 2025/0381531 A1
(43) Pub. Date: Dec. 18, 2025

(54) HOMOGENIZING VALVE

(71) Applicant: HAMMELMANN GMBH, Oelde (DE)

(72) Inventors: Mauro BANDINI, Parma (IT); David FERSINI, Colorno (Parma) (IT); Fabian STOFFERS, Rheda-Wiedenbrück (DE); Egbert HELMIG, Ennigerloh (DE)

(21) Appl. No.: 18/877,297

(22) PCT Filed: Jun. 19, 2023
(86) PCT No.: PCT/EP2023/066450

§ 371 Date: Dec. 20, 2024

(30) Foreign Application Priority Data
Jun. 22, 2022 (DE) 10 2022 115 580.3

(51) Int. Cl. B01F 25/00; F16K 11/07

(52) U.S. Cl. CPC B01F 25/1051; F16K 11/07

(57) ABSTRACT

A homogenizing valve has a valve housing with inlet and outlet channels, a valve seat, and a receptacle through which a valve body extends movably in the direction of its longitudinal axis. A pressure chamber is connected to the inlet channel and formed integrally in the receptacle of the valve seat and/or the jacket surface of the valve body. An adjustment unit is operatively connected to the valve body and with which the axial position of the valve body in the receptacle is adjustable. The valve seat together with the valve body, on both sides of the pressure chamber in the direction of movement of the valve body, have a shear gap formed by a blade edge and by a wall region shaped conically with respect to the latter and, downstream of the shear gap in the direction of flow, an expansion chamber connected to the outlet channel.

### BACKGROUND AND SUMMARY OF THE INVENTION

Exemplary embodiments of the present invention relate to a homogenizing valve and to a further homogenizing valve.

Such homogenizing valves are used to evenly divide the different components in fruit juices or dairy products or the like and distribute them homogeneously in the medium. For this purpose, the medium to be homogenized is passed under high pressure (usually greater than 150 bar) over a shearing edge, behind which the medium to be homogenized expands and, in particular, fruit fibers in a fruit juice or fat droplets in emulsions such as milk are effectively crushed.

Particularly when using high pressures for homogenization, large adjustment forces are required to set a homogenization gap in the homogenization valve. The large adjustment forces required result from the operating pressure acting on pressurized surfaces of the valve body in the direction of adjustment of the valve body.

Exemplary embodiments of the present invention are directed to a homogenizing valve whose valve body can be controlled or moved with significantly lower adjustment forces.

The homogenizing valve according to the invention for a medium to be homogenized under system pressure has a valve housing having an inlet channel and an outlet channel for the medium.

The homogenizing valve also has a valve seat arranged in the valve housing with a receptacle through which a valve body extends movably in the direction of its longitudinal axis.

A pressure chamber, which is connected to the inlet channel, is formed in the seat of the valve and/or the outer jacket surface of the valve body.

Furthermore, an adjustment unit is provided that is operatively connected to the valve body. The axial position of the valve body in the receptacle can be adjusted using the adjustment unit. Axial movement is to be understood as a movement axially to an imaginary central axis of the receptacle.

By moving the valve body in the valve seat, the flow resistance from the inlet channel to the outlet channel can be regulated.

Between the inner wall of the valve seat forming the receptacle and the valve body, a shear gap, formed by a blade edge and a conically shaped wall region opposite the blade edge, and an expansion chamber, which is provided downstream of the shear gap in the direction of flow and is connected to the outlet channel, are formed on both sides of the pressure chamber, as viewed in the direction of displacement of the valve body.

The arrangement of such a shear gap on both sides of the pressure chamber means that virtually no resulting force acts on the movable valve body in the direction of the longitudinal axis of the valve body, which corresponds to the direction of movement of the valve body.

Accordingly, the shear gap can be adjusted by moving the valve body using the adjustment unit with very little effort.

According to an advantageous embodiment variant, the length of a first of the blade edges close to the adjustment unit is greater in the circumferential direction than the length of a second of the blade edges, which is arranged at a distance from the adjustment unit.

This makes it extremely easy to install the valve body in the valve seat in the axial direction.

According to a preferred further development, the blade edges are double-conical in shape when viewed in the direction of the longitudinal axis of the valve body.

According to a first preferred embodiment variant, the blade edges are positioned on an outer jacket surface of the valve body between conically shaped regions of the receptacle in the direction of displacement of the valve body.

In particular, it is possible to form the blade edges on the outer jacket surface of the valve body in an extremely precise manner when shaping the valve body.

According to a further embodiment variant, the blade edges are designed as separate components attached to the outer jacket surface of the valve body. This design makes it possible to manufacture the components of the valve body from different materials. In particular, the blade edges can be made of a particularly hard material to further increase their service life.

According to an alternative embodiment variant, an inverted arrangement is also conceivable, in which the blade edges are positioned on an inner surface of the valve seat between regions of the outer jacket surface of the valve body which are conically shaped in the direction of displacement of the valve body.

Both embodiment variants allow the shear gap to be easily adjusted by moving the valve body in the valve seat.

According to a further preferred embodiment variant, guide surfaces are provided on the inner surfaces of the valve seat and jacket surfaces of the valve body, wherein grooves connected to the respective expansion chamber are provided on the guide surfaces of the valve seat and/or the valve body.

The grooves cause an additional counter-flow of the expanded medium by channeling the medium as it enters the grooves from the expansion chamber.

According to a preferred further development, the grooves extend linearly parallel to the direction of movement of the valve body. A curved design of the grooves is also conceivable.

In a preferred embodiment variant, the grooves are formed in the guide surfaces of the valve body.

In an alternative embodiment variant, the grooves are formed in the guide surfaces of the valve seat.

According to a further preferred embodiment variant, the guide surfaces of the valve body and the valve seat are conically shaped in the direction of the longitudinal axis of the valve body.

In an alternative embodiment variant, the guide surfaces of the valve body and the valve seat are cylindrically shaped in the direction of the longitudinal axis of the valve body.

This embodiment variant enables even more precise guidance of the valve body in the valve seat.

According to a further preferred embodiment variant, channels connected to the outlet are provided in the valve housing downstream of the valve body.

According to a preferred further development, these channels open into a mixing region of the outlet or a mixing chamber upstream of the outlet, wherein a nozzle is arranged upstream in each of the channels, the jet direction of which is aligned with one another.

These nozzles enable a reciprocal flow of the already expanded medium, which further increases the quality of the homogenization.

In a further preferred embodiment variant, a diameter of the conically shaped seat and of the part of the valve body with the conically shaped outer jacket surface is designed to increase towards the adjustment unit.

The valve seat is preferably installed in a receptacle of the valve housing to prevent movement.

It is also conceivable, as an alternative embodiment variant, to form the valve seat as a component of the valve housing.

In another preferred embodiment variant, an elastic unit is arranged between the adjustment unit and the valve body.

The elastic unit, preferably designed as a spring assembly having at least two disk springs, thus makes it easy to prevent a blockage in the pressure chamber, since when the operating pressure rises, the valve body is briefly moved in the direction of the adjustment unit to relieve the pressure due to the different surfaces of the blade edges on both sides of the pressure chamber, wherein the gap height increases briefly until the initial operating pressure in the pressure chamber is reached again and as a result the valve body is automatically pressed back into its initial position by the force of the elastic unit.

A further alternative embodiment variant of a homogenizing valve according to the invention has a valve housing with an outlet channel for the medium and a valve seat arranged in the valve housing along an axis of displacement with an at least partially conically shaped receptacle in which a valve body fixed to the valve housing is mounted with an at least partially conically shaped outer jacket surface and an inlet channel.

A pressure chamber is connected to the inlet channel, which is formed in the receptacle of the valve seat and/or the outer jacket surface of the valve body.

An adjustment unit is operatively connected to the valve seat. A medium flow from the inlet channel to the outlet channel can be regulated by the interaction of the valve body with the valve seat.

Here too, a shear gap is formed between the inner wall of the valve seat forming the receptacle and the valve body in the direction of displacement of the valve body on both sides of the pressure chamber by a blade edge and a wall region that is conically shaped in relation to it, and an expansion chamber connected to the outlet channel is formed downstream of the shear gap in the direction of flow.

In this embodiment variant, too, the central feed of the medium to be homogenized through the valve body into the pressure chamber, from where the medium continues to flow over the blade edges in the direction of displacement of the valve body, makes it possible to adjust the shear gap with very little effort, in this case by displacing the valve seat.

### BRIEF DESCRIPTION OF THE DRAWING FIGURES

In the following, preferred exemplary embodiments are explained in more detail with reference to the accompanying drawings, wherein:

FIG. 1 shows a schematic sectional view of an embodiment variant of a homogenizing valve according to the invention with a fixed valve seat and axially movable valve body,

FIG. 2 shows a sectional view corresponding to FIG. 1 with a top view of a non-intersected valve body,

FIG. 3 shows a sectional view of a further embodiment variant of a homogenizing valve with additional nozzles, corresponding to FIG. 1,

FIG. 4 shows a single isometric view of an embodiment variant of a valve body with blade edges formed thereon and guide surfaces provided with grooves,

FIG. 5 shows a sectional view through the valve body shown in FIG. 4, inserted into a valve seat,

FIG. 6 shows an isometric sectional view of a valve seat with blade edges and guide surfaces arranged in the receiving chamber with grooves provided therein,

FIG. 7 shows a sectional view through the valve seat shown in FIG. 6 with the valve body with conically shaped jacket surface inserted therein,

FIGS. 8 and 9 show sectional views of further embodiment variants of valve seats and valve bodies accommodated therein, corresponding to FIGS. 5 and 7,

FIG. 10 shows a schematic sectional view of a further embodiment variant of a homogenizing valve according to the invention with movable valve seat and fixed valve body, and

FIG. 11 shows representation of a further embodiment variant of a homogenizing valve according to the invention with an additional elastic unit between the valve body and the adjustment unit, corresponding to FIG. 1.

### DETAILED DESCRIPTION

In the following description of the figures, terms such as top, bottom, left, right, front, rear, etc. refer exclusively to the exemplary representation and position of the homogenizing valve, valve housing, valve seat, valve body, blade edges, expansion chamber and the like selected in the respective figures. These terms are not to be understood restrictively, i.e. these references may change due to different operating positions or the mirror-symmetrical design or the like.

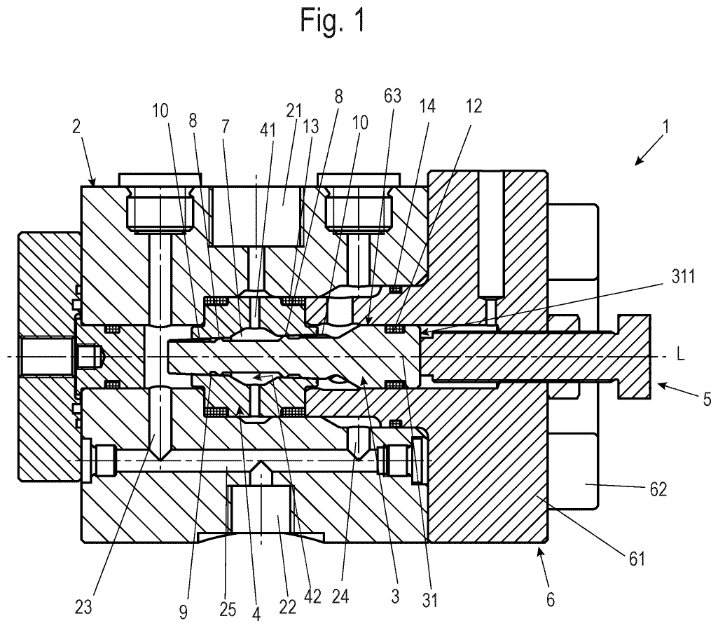

In FIG. 1, the reference sign 1 designates an embodiment variant of a homogenizing valve according to the invention in its entirety.

The homogenizing valve 1 has a valve housing 2 with an inlet channel 21 and an outlet channel 22 for the medium to be homogenized.

A valve seat 4 is arranged in the valve housing 2. The valve seat 4 has a receptacle 42 through which a valve body 3 of the homogenizing valve 1 extends movably in the direction of its longitudinal axis L.

As shown in FIG. 1, the valve seat 4 can be designed as a separate component that is installed in the valve housing 2 and sealed off from the valve housing 2 by static high-pressure seals 13.

It is also conceivable to form the valve seat 4 in one piece with the valve housing 2.

The receptacle 42 of the valve seat 4 is designed as a through opening through which a valve region 33 of the valve body 3 extends.

The axial position of the valve body 3 in the receptacle 42 can be adjusted with the aid of an adjustment unit 5, for example in the form of a manually rotatable screw, as shown in FIG. 1.

In the exemplary embodiment shown, the adjustment unit 5 is screwed into a guide housing 6, the body 61 of which is firmly screwed to the valve housing 2 using fixing screws 62.

In the embodiment variant shown here, the guide housing 6 has a receptacle 63 which extends into a receptacle in the valve housing 2. The inner surfaces of this receptacle 63 serve as guide surfaces for a head 31 of the valve body 3, the guide jacket 312 of which forms sliding surfaces that can be displaced on the inner surface of the receptacle 63 of the guide housing 6 in the direction of the longitudinal axis L of the valve body 3. The longitudinal axis L is also the (imaginary) center axis of the receptacle 42.

To seal the head 31 of the valve body 3 against the inner walls of the receptacle 63 of the guide housing 6, the guide jacket 312 of the head 31 of the valve body 3 is provided with a seal-receiving groove 313, in which a dynamic low-pressure seal 12 is accommodated.

The end face 311 of the head 31 of the valve body 3 serves as a contact surface for an end face of the adjustment unit 5.

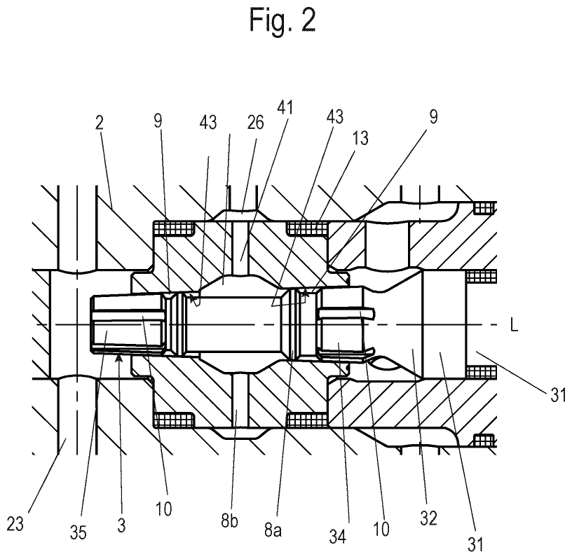

As further shown in FIGS. 1 and 2, a pressure chamber 7 connected to the inlet channel 21 is formed in the receptacle 42 of the valve seat 4 and/or the outer jacket surface 33 of the valve body 3.

In the embodiment variant shown in FIGS. 1 and 2, the receptacle 42 of the valve seat 4 is widened in an annular shape around a pressure chamber inlet channel 41 to form the pressure chamber 7.

Between the inner wall of the valve seat 4 forming the receptacle 42 and the valve body 3, as further shown in FIGS. 1 and 2, a shear gap is formed in each case on both sides of the pressure chamber 7 by a blade edge 8a, 8b and a wall region that is conically shaped with respect thereto, and an expansion chamber 9 connected to the outlet channel 22 is formed downstream of the shear gap in the direction of flow.

Since the medium to be homogenized is fed into the pressure chamber 7 under high pressure, in particular more than 150 bar, via the inlet channel 21, the blade edges 8a, 8b provided on both sides of the pressure chamber 7 ensure that virtually no force is exerted on the movable valve body 3 by the medium under high pressure in the direction of movement of the valve body 3, i.e., in the direction of a longitudinal axis L.

The shear gap is adjusted by moving the valve body 3 relative to the valve seat 4. The gap dimension of the shear gap between the blade edges 8a, 8b and the conically shaped wall regions is the same for both sides.

Depending on the medium to be homogenized, a preferred setting of the gap dimension is preferably in a range between 0.01 mm and 0.1 mm.

In all of the embodiment variants shown, the length of the blade edge 8a close to the adjustment unit 5 is greater in the circumferential direction than the length of the blade edge 8b remote from the adjustment unit 5. Accordingly, the inner diameter of the receptacle 42 in the area close to the adjustment unit 5 is larger than the inner diameter of the receptacle 42 away from the adjustment unit 5.

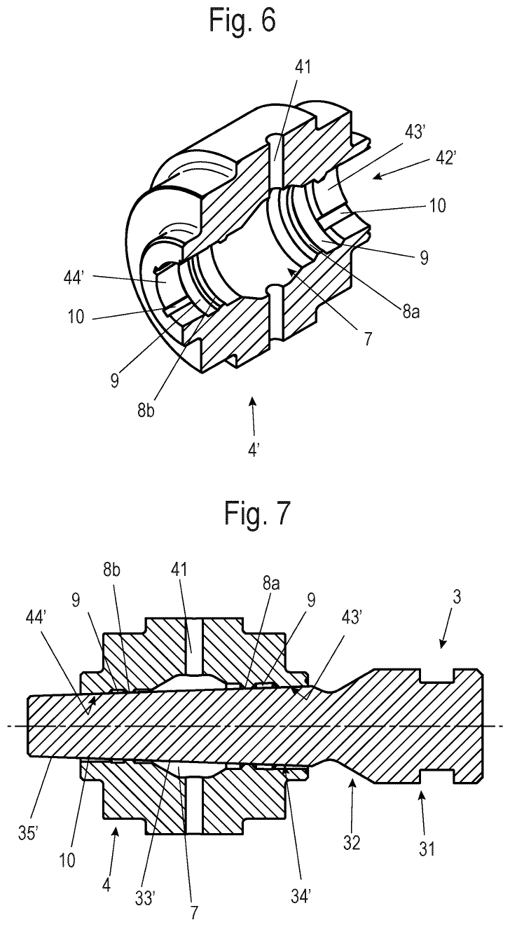

The blade edges 8a, 8b are preferably of double conical design, with a front flank narrowing the shear gap from the pressure chamber 7, a short section of constant radial width adjoining this in the direction of the longitudinal axis L of the valve body 3, and a rear flank adjoining this section and widening the shear gap towards the expansion chamber 9.

Whereas in the embodiment variants of the homogenizing valve 1 shown in FIGS. 1 to 5, the blade edges 8a, 8b are positioned on an outer jacket surface of the valve body 3 between regions of the receptacle 42 that are conically shaped in the direction of displacement of the valve body 3, the valve region 33′ of the valve body 3 is linearly conical in the embodiment variant shown in FIGS. 6 and 7.

The blade edges 8a, 8b are positioned here on an inner surface of the valve seat 4 forming the receptacle 42 between conically shaped areas of the outer jacket surface of the valve body 3 in the direction of displacement of the valve body 3.

In the embodiment variant shown in FIGS. 6 and 7, the annular expansion chamber 9 is also molded into the inner wall of the valve seat 4′ forming the receptacle 42′.

In both embodiment variants, the blade edges 8a, 8b can be integrally formed on the respective component, i.e., on the valve body 3 in the embodiment shown in FIGS. 1 to 5 or on the valve seat 4, or can be formed as a separate component that is attached to the valve body 3 or to the valve seat 4.

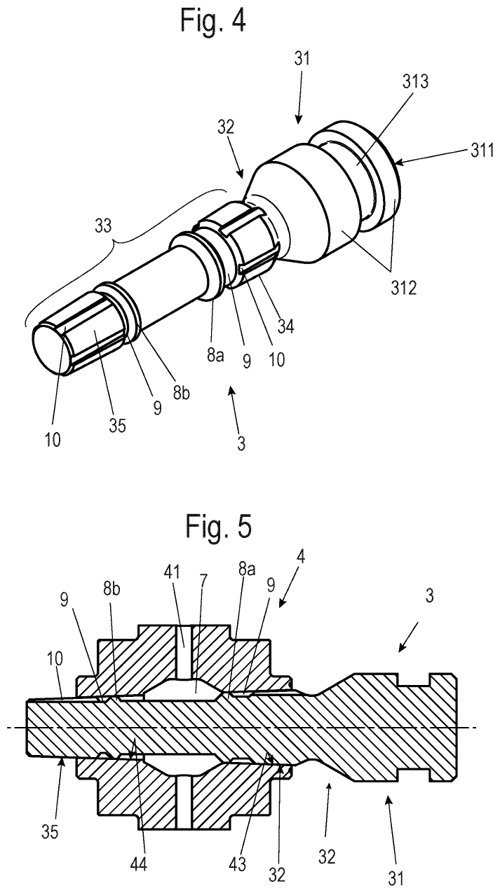

As can also be clearly seen in FIGS. 2 and 4, guide surfaces 34, 35, 43, 44 are provided on the inner surfaces of the valve seat 4 and jacket surfaces of the valve body 3, wherein grooves 10 connected to the respective expansion chamber 9 are provided on the guide surfaces 43, 44 of the valve seat 4 or guide surfaces 34, 35 of the valve body 3.

In the embodiment variant of the homogenizing valve 1 shown in FIGS. 1 to 5, these grooves 10 are provided in the guide surfaces 34, 35 of the valve body 3. The grooves 10 preferably extend linearly parallel to the direction of movement of the valve body 3.

As can be clearly seen in FIG. 6, the grooves 10 are formed into the guide surfaces 43, 44 of the valve seat 4 in the alternative embodiment variant of the homogenizing valve 1.

As can also be seen in FIGS. 1 to 8, the guide surfaces 34, 35, 43, 44 of the valve body 3 and the valve seat 4 are conically shaped in the direction of the longitudinal axis L of the valve body 3.

In the further embodiment variant shown as an example in FIG. 9, the guide surfaces 34″, 35″, 43′″ and 44″ are cylindrical, wherein the diameter of the valve body 3 and correspondingly the receptacle 42 of the valve seat 4 in the area of the guide surfaces 34, 43′ is larger than the diameter in the region of the guide surfaces 35″, 44″.

The design of these guide surfaces 34″, 35″, 43″, 44′″ as cylindrical surfaces enables even better guidance of the valve body 3 in the valve seat 4, because in this case the guide surfaces are in sliding contact with the receptacle 42 in every position of the valve body 3.

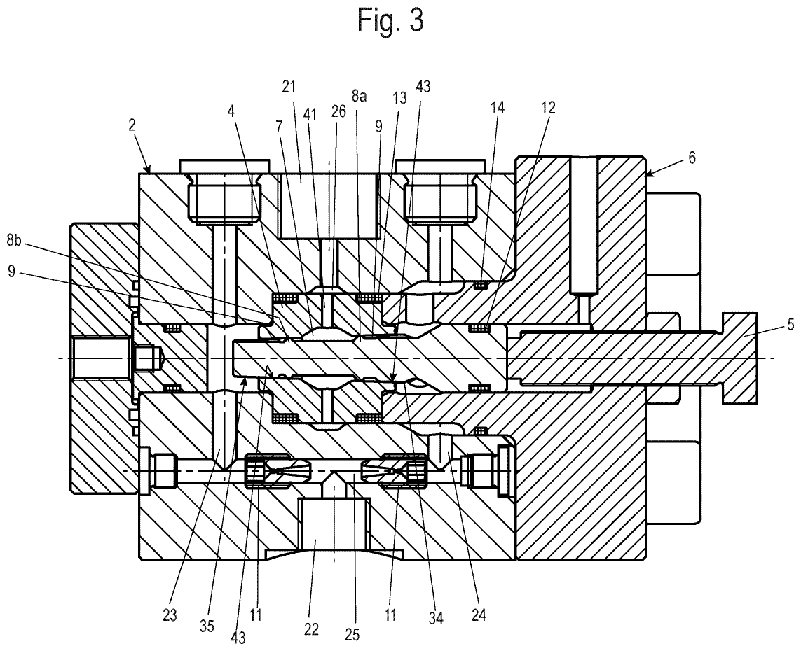

As further illustrated in the embodiment variant shown in FIG. 3, channels 23, 24 preferably connected to the outlet 22 are provided in the valve housing 2 downstream of the valve body 3.

These channels 23, 24 open into a mixing region of the outlet 22 or a mixing chamber 25 upstream of the outlet, so that the medium to be homogenized is recombined after expansion in the two expansion chambers 9 in the mixing region of the outlet 22 or in the mixing chamber 25 upstream of the outlet with mutual inflow.

Preferably, a nozzle 11 is arranged in each of the channels 23, 24, wherein the jet directions of the nozzles 11 are aligned in such a way that the two media flows directed through the respective nozzles 11 meet at an accelerated rate in the mixing region of the outlet 22 or in the mixing chamber 25 upstream thereof.

A reciprocal inflow of partial flows of the medium also takes place in the two expansion chambers 9, there in the transition region to the grooves 10, through which the medium is discharged from the region of the valve body 3 into the channels 23, 24.

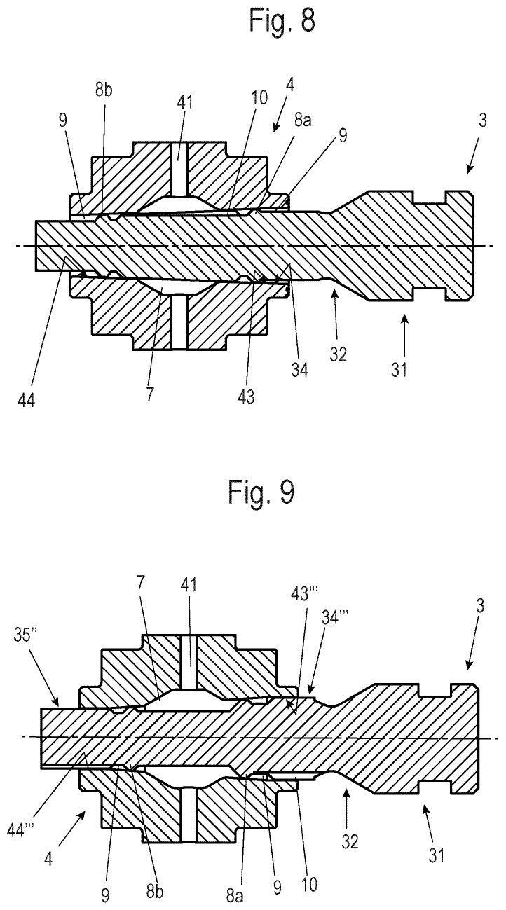

It is also conceivable, as shown as an example in FIG. 8, to swap the position of the blade edges 8a, 8b and the guide surfaces 34, 35, 43, 44, so that the medium is first guided through the grooves 10 after entering the pressure chamber and is then guided into the respective expansion chambers 9 via the blade edges 8a, 8b.

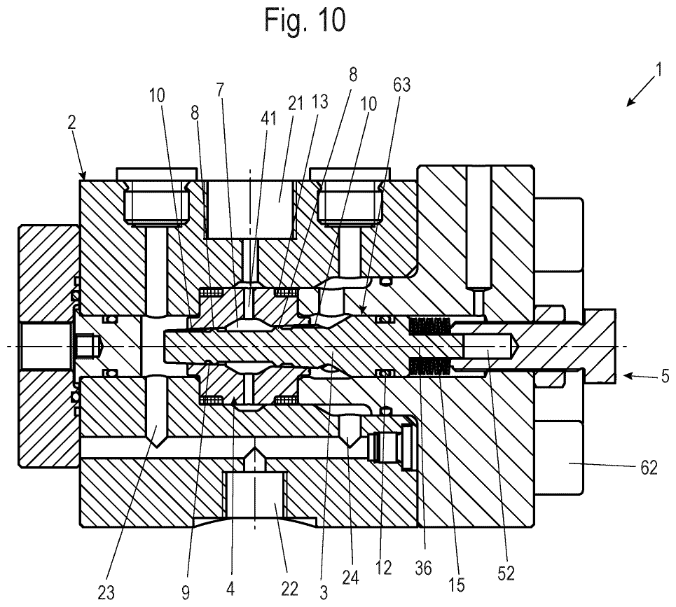

In the further embodiment variant shown in FIG. 10, an elastic unit 15 is arranged between the adjustment unit 5 and the valve body 3. The

The elastic unit 15, designed here as a spring assembly with several, in particular at least two disk springs, serves to ensure that, if the operating pressure increases too much during operation, for example due to a blockage in the pressure chamber 7, the valve body 3 moves against the force of the elastic unit 15 to relieve the pressure and thus increases the gap height until the operating pressure reaches its initial value again, so that the valve body 3 is pressed back into the initial position by the elastic unit 15.

The movement of the valve body 3 against the force of the elastic unit 15 is based on the difference between the area of the blade edge 8a on the side of the pressure chamber 7 close to the adjustment unit 5 and the area of the blade edge 8b on the side of the pressure chamber 7 remote from the adjustment unit 5, wherein the area of the blade edge 8a on the side of the pressure chamber 7 close to the adjustment unit 5 is larger than that of the area of the blade edge 8b on the side of the pressure chamber 7 remote from the adjustment unit 5.

In this case, adjusting the adjustment unit 5 primarily enables the holding force of the elastic unit 15 to be adjusted.

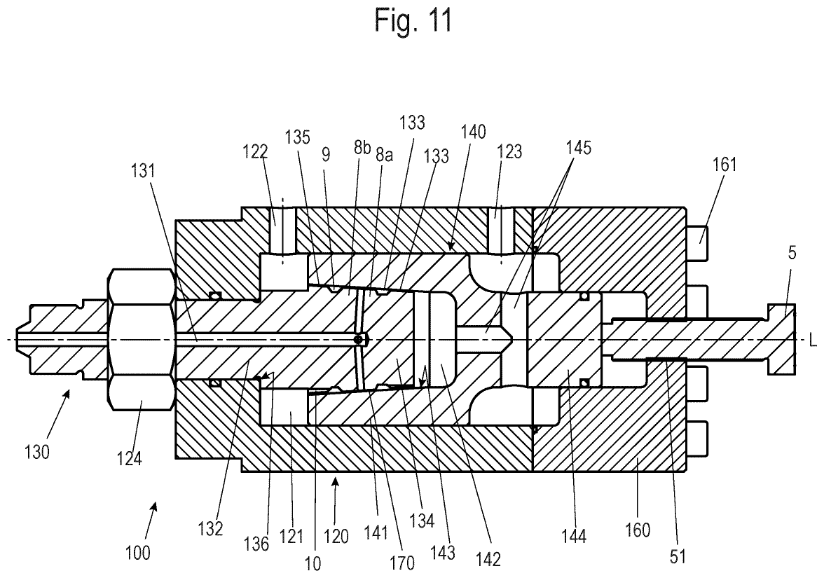

Another embodiment variant of such a homogenizing valve 100 is shown in FIG. 11.

In this embodiment variant, the valve housing 120 is formed with outlet channels 122, 123 for the medium. A valve seat 140 arranged along a displacement axis L is provided in the valve housing 120, also with an at least partially conically shaped receptacle 142, in which a valve body 130 fixed to the valve housing 120 in this case is mounted with an at least partially conically shaped outer jacket surface 133 and an inlet 131.

The inlet 131 is designed here as a channel formed into the valve body along the longitudinal axis from one end face, from the end of which several channels branch off radially or approximately radially into a pressure chamber 170, which is integrally formed in the receptacle 142 of the valve seat 140 and/or the outer jacket surface 133 of the valve body 130. The pressure chamber 170 is also annularly grooved, as in the embodiment variants shown in FIGS. 1 to 9. The material recess for forming the pressure chamber 170 is preferably provided here in the valve body 130.

Furthermore, in this embodiment variant, an adjustment unit 150 is operatively connected to the valve seat 140. A medium flow from the inlet 131 to the outlet channel 122 in the valve housing 120 can be regulated here by moving the valve seat 140 relative to the valve body 130, which is permanently mounted on the valve housing 120.

Here, too, a shear gap formed by a blade edge 8a, 8b and a wall region which is conically shaped with respect thereto is formed between the inner wall of the valve seat 140 forming the receptacle 142 and the valve body 130 on both sides of the pressure chamber 170 in the direction of displacement of the valve body 130, and an expansion chamber 9 connected to the outlet channel 122 is formed downstream of the shear gap in the direction of flow.

Furthermore, grooves 10 are also provided downstream of the expansion chambers 9 in this embodiment variant, which can also be formed either on the outer jacket surface 133 of the valve body 130 or on the inner surface of the valve seat 140 forming the receptacle 142.

In the exemplary embodiment shown, the blade edges 8a, 8b are formed by the edges of the outer jacket surface 133 of the valve body 130 at the transition to the expansion chambers 9.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Homogenizing valve
2 Valve body
21 Input channel
22 Output channel
23 Channel
24 Channel
25 Mixing chamber
26 Ring chamber
3 Valve body
31 Head
311 End face
312 Guide jacket
313 Seal-receiving groove
32 Transition region
33 Valve region
34, 34′, 34″ Guide surface
35, 35′, 35″ Guide surface
36 Guide pin
4 Valve seat
41 Pressure chamber inlet channel
42 Receptacle
43, 43′, 43″ Guide surface
5 Adjustment unit
51 Thread
52 Guide holder
6 Guide housing
61 Body
62 Fixing screw
63 Receptacle
7 Pressure chamber
8a, b Blade edge
9 Expansion chamber
10 Groove
11 Nozzle
12 Dynamic low-pressure seal
13 Static high-pressure seal
14 Low-pressure seal
15 Elastic unit
100 Homogenizing valve
120 Valve body
121 Low-pressure chamber
122 Output channel
123 Output channel
130 Valve body
131 Inlet
132 Neck
133 Outer jacket surface
134 Head
135 Conical region
140 Valve seat
141 Conical section
142 Receptacle
143 Guide surface
144 Head
145 Channel
160 Guide housing
161 Body
162 Fixing screw
163 Valve seat retainer
x, y Direction
L Longitudinal axis

1-19. (canceled)

20. A homogenizing valve for a medium to be homogenized under system pressure, the homogenizing valve comprising:
a valve housing having at least one inlet channel and at least one outlet channel for the medium;
a valve seat, arranged in the valve housing, with a receptacle through which a valve body extends movably in a direction of a longitudinal axis of the valve body;
a pressure chamber connected to the inlet channel, the pressure chamber is formed in the receptacle of the valve seat or an outer jacket surface of the valve body; and
an adjustment unit operatively connected to the valve body and with which an axial position of the valve body in the receptacle is adjustable,
wherein a flow resistance within the receptacle is regulatable by displacing the valve body in the valve seat, and
wherein there is a shear gap on both sides of the pressure chamber in a direction of displacement of the valve body and between an inner wall of the valve seat forming the receptacle and the valve body,
wherein the shear gap is respectively formed by a blade edge and a wall region that is conically shaped relative the respective blade edge, and
wherein an expansion chamber connected to the outlet channel is arranged downstream of the shear gap in a direction of flow.

21. The homogenizing valve of claim 20, wherein a length of a first of the blade edges is greater in a circumferential direction than a length of a second of the blade edges, wherein the first of the blade edges is close to the adjustment unit and the second of the blade edges is arranged at a distance from the adjustment unit.

22. The homogenizing valve of claim 20, when view in a direction of the longitudinal axis, the blade edges have a double-conical shape.

23. The homogenizing valve of claim 20, wherein the blade edges are positioned on an outer jacket surface of the valve body between conically shaped regions of the receptacle in the direction of displacement of the valve body.

24. The homogenizing valve of claim 23, wherein the blade edges are positioned on an inner surface of the valve seat between regions of the outer jacket surface of the valve body, which are conically shaped in the direction of displacement of the valve body.

25. The homogenizing valve of claim 20, further comprising:
guide surfaces on the inner wall of the valve seat and outer jacket surfaces of the valve body, wherein grooves connected to the respective expansion chamber are provided on the guide surfaces of the valve seat or of the valve body.

26. The homogenizing valve of claim 25, wherein the grooves extend linearly parallel to the direction of displacement of the valve body.

27. The homogenizing valve of claim 25, wherein the grooves extend in a curved manner with respect to the direction of displacement of the valve body.

28. The homogenizing valve of claim 25, wherein the grooves are formed in the guide surfaces of the valve body.

29. The homogenizing valve of claim 25, wherein the grooves are formed in the guide surfaces of the valve seat.

30. The homogenizing valve of claim 25, wherein the guide surfaces of the valve body and the valve seat are conically shaped in the direction of the longitudinal axis of the valve body.

31. The homogenizing valve of claim 25, wherein the guide surfaces of the valve body and the valve seat are cylindrically shaped in the direction of the longitudinal axis of the valve body.

32. The homogenizing valve of claim 20, wherein channels connected to the outlet are provided in the valve housing downstream of the valve body.

33. The homogenizing valve of claim 32, wherein the channels open into a mixing region of the outlet or a mixing chamber upstream of the outlet.

34. The homogenizing valve of claim 30, wherein a diameter of the conically shaped receptacle and of a part of the valve body formed with a conically shaped outer jacket surface is designed to increase towards the adjustment unit.

35. The homogenizing valve of claim 20, wherein the valve seat is installed in the receptacle of the valve housing in such a way that it cannot move or is a component of the valve housing.

36. The homogenizing valve of claim 20, further comprising:
an elastic unit arranged between the adjustment unit and the valve body.

37. The homogenizing valve of claim 36, wherein the elastic unit is a spring assembly having at least two disk springs.

38. A homogenizing valve for a medium to be homogenized which is under system pressure, the homogenizing valve comprising:
a valve housing with at least one outlet channel for the medium;
a valve seat, arranged in the valve housing along an axis of displacement, having an at least partially conically shaped receptacle in which a valve body fixed to the valve housing is mounted with an at least partially conically shaped outer jacket surface and an inlet channel;
a pressure chamber connected to the inlet channel, which is formed in the receptacle of the valve seat or an outer jacket surface of the valve body; and
an adjustment unit operatively connected to the valve seat,
wherein a flow resistance within the receptacle is regulatable by displacing the valve body in the valve seat,
wherein there is a shear gap on both sides of the pressure chamber in a direction of displacement of the valve body and between an inner wall of the valve seat forming the receptacle and the valve body,
wherein the shear gap is respectively formed by a blade edge and a wall region that is conically shaped relative the respective blade edge, and
wherein an expansion chamber connected to the outlet channel is arranged downstream of the shear gap in a direction of flow.
